(19) United States
(12) Patent Application Publication
(10) Pub. No.: US 2020/0239708 A1
(43) Pub. Date: Jul. 30, 2020

(54) Anticorrosive Grafted Graphene Filler for Organic Coating and Methods of Preparing the Same

(71) Applicant: Golconda International Trade & Investment Co., Limited, Hong Kong (HK)

(72) Inventor: Wai Hung YEUNG, Hong Kong (HK)

(21) Appl. No.: 16/357,734

(22) Filed: Mar. 19, 2019

(30) Foreign Application Priority Data
Jan. 29, 2019 (CN) 201910083318.8

(51) Int. Cl. C09D 5/08; C09C 1/44; C09D 7/62

(52) U.S. Cl. CPC C09D 5/086; C09D 7/62; C09C 1/44

(57) ABSTRACT

The invention relates to an anticorrosive grafted graphene filler for an organic coating, consisting of the following materials by weight: 0.1-0.2 parts of triterpenoid saponin, 2-3 parts of phytic acid hexaphosphate, 0.6-1 part of anticorrosive additive, 2-4 parts of dodecafluoroheptylpropyltrimethoxysilane, 10-15 parts of precursor, 110-120 parts of graphene oxide, 1-2 parts of 3-aminopropyltriethoxysilane. The composite of the present invention exhibits better performance, can be applied to an organic coating material and has good corrosion resistance to the metal substrate. The composite material of the invention has good stability and superior comprehensive performance.

### FIELD OF THE INVENTION

The invention relates to the field of materials, and particularly relates to an anticorrosive grafted graphene filler for an organic coating and a method of preparing the same.

### BACKGROUND

As graphene has unique structural flexibility, high electrical conductivity, excellent thermal stability and large specific surface area, graphene has broad prospects in the preparation and application of nanomaterials. The combination of graphene with excellent properties and other functional nanomaterials to prepare graphene-based nanocomposites is an effective way to expand the application range of graphene. On the one hand, these functional nanomaterials can enlarge the sheet distance of graphene in the solid state and prevent it from accumulating into graphite structure and thereby maintain the superior performance of graphene. On the other hand, recent research shows that there is a synergistic effect between graphene and these functional nanomaterials, so that the composite exhibits better performance than single component, and even produces some new features. Therefore, more and more versatile graphene composites are under continuous research.

The reduction of graphite oxide is a process of removing oxygen-containing functional groups on the surface of graphene, and the modification of graphene is done by other functional groups or nanocomposites. Graphene itself is neither hydrophilic nor oleophilic. It is difficult to disperse in various solvents, and it is difficult to effectively compound with other substances including inorganic nanoparticles. Therefore, it is necessary to chemically modify the surface of graphene to improve its operability. Generally, the modification of graphene includes covalent bond modification and non-covalent bond modification. The covalent bond modification is to interconnect the functional group with the surface of the graphene in a covalent bond. However, the covalent bond modification is difficult to carry out on the graphene surface, and the oxygen-containing functional group on the surface of the graphene oxide is often used as a reactive site. The main advantage of non-covalently modified graphene is that the introduction of functional groups does not destroy the conjugated structure of graphene itself, so that the excellent properties of graphene are retained. The purpose of the present invention is to solve the problem of how to effectively crosslink the graphene and the nanoparticles, and allow them to be dispersed in various organic solvents by the surface modification.

### SUMMARY OF THE INVENTION

The purpose of the present invention is to solve the problem of how to form effective cross-linking of graphene and nanoparticles, and then allow them to be dispersed in various organic solvents by surface modification, and provide an anticorrosive grafted graphene filler for an organic coating and a method of preparing the same.

The technical solution of the present invention is as follows.

An anticorrosive grafted graphene filler for an organic coating consists of the following materials by weight: 0.1-0.2 parts of triterpenoid saponin, 2-3 parts of phytic acid hexaphosphate, 0.6-1 part of anticorrosive additive, 2-4 parts of dodecafluoroheptylpropyltrimethoxysilane, 10-15 parts of precursor, 110-120 parts of graphene oxide, 1-2 parts of 3-aminopropyltriethoxysilane.

The anticorrosive additive is a mixture of one or two of ethylene diamine tetramethylene diphosphonate sodium and petroleum sodium sulfonate. When it is a mixture, the mass ratio of ethylene diamine tetramethylene diphosphonate sodium and petroleum sodium sulfonate is 2-3:1.

The precursor is aluminum isopropoxide.

A method of preparing an anticorrosive grafted graphene filler for an organic coating, comprising:

(1) The anti-corrosive additive is added to deionized water with the weight of 76-80 times weight of anti-corrosive additive, stirring evenly. Triterpenoid saponin is added and stirred at 60-70° C. for 4-10 minutes to obtain anticorrosive dispersion.

(2) The precursor is added to the anticorrosive dispersion, stirring evenly. 3-5 mol/l ammonia water is dropped, and pH is adjusted to 10-12, stirring at room temperature for 2-3 hours. After suction filtration, the filter cake was washed with water and dried under vacuum at 90-100° C. for 1-2 hours to obtain an anticorrosive sol.

(3) Phytic acid hexaphosphate is added to deionized water with a weight of 30-40 times weight of phytic acid hexaphosphate, stirring evenly. The anti-corrosive sol is added, and sent to a constant temperature water bath of 60-65° C., stirring for 1-2 hours, and discharged and centrifuged. The precipitation is washed and dried at room temperature to obtain a carboxylated anticorrosive sol.

(4) The carboxylated anticorrosive sol is added to thionyl chloride with a weight of 17-20 times weight of the carboxylated anticorrosive sol, stirred at 50-55° C. for 15-20 hours. Thionyl chloride is removed by distillation. Acyl chloride anticorrosive sol is obtained by drying at room temperature.

(5) Graphene oxide is added to anhydrous ethanol with a weight of 100-200 times weight of graphene oxide, stirred at 1000-1400 rpm for 3-4 hours. 3-aminopropyltriethoxysilane is added. Anhydrous ethanol is removed by distillation to obtain aminated graphene oxide.

(6) Dodecafluoroheptylpropyltrimethoxysilane is added methyl nylon with a weight of 30-48 times weight of dodecafluoroheptylpropyltrimethoxysilane with sonicated 1-2 minutes to obtain a silane ester solution.

(7) The acyl chloride anticorrosive sol is mixed with the aminated graphene oxide and the mixture is added to deionized water with a weight of 30-40 times the weight of deionized water, sonicated for 10-20 minutes and filtered. The precipitate is washed with water, dried at room temperature, added to the silane ester solution. The temperature is raised to 60-70° C., and the mixture is stirred at 800-1000 rpm for 1-2 hours, filtered, and the precipitate is dried to obtain an anticorrosive grafted graphene filler for the organic coating.

The specific method for drying the precipitate in the step (7) is as follows: the precipitate is washed 3-4 times with methyl nylon methylate and deionized water, and dried under vacuum at 100-110° C. for 1-2 hours.

The technical effect of the present invention is as follows.

The invention adopts aluminum isopropoxide as a precursor, and is hydrolyzed in an aqueous dispersion of an anticorrosive additive. The obtained anticorrosive sol is treated by phytic acid hexaphosphate, to obtain a carboxylated anticorrosive sol. It is then subjected to acid chloride treatment with thionyl chloride to obtain acyl chloride anticorrosive sol. Graphene oxide is further aminated in the invention, and mixed with acyl chloride anticorrosive sol to carry out a crosslinking reaction. The anticorrosive sol is effectively attached to the surface of the graphene to obtain an anticorrosive composite graphene material, and finally, is dispersed in a solution of methyl nylon nitrate in the silane to obtain a composite material which can be dispersed in an organic solvent. The composite material has good strength, can be applied to an organic coating material and has good corrosion resistance to the metal substrate. The composite material of the invention has good stability and superior comprehensive performance.

### DETAILED DESCRIPTION

### Example 1

An anticorrosive grafted graphene filler for an organic coating consists of the following materials by weight: 0.1 part of triterpenoid saponin, 2 parts of phytic acid hexaphosphate, 0.6 part of ethylene diamine tetramethylene diphosphonate sodium, 2 parts of dodecafluoroheptylpropyltrimethoxysilane, 15 parts of aluminum isopropoxide, 120 parts of graphene oxide, 2 parts of 3-aminopropyltriethoxysilane.

A method of preparing an anticorrosive grafted graphene filler for an organic coating, comprising:

(1) The anti-corrosive additive is added to deionized water with the weight of 76 times weight of anti-corrosive additive, stirring evenly. Triterpenoid saponin is added and stirred at 60° C. for 4 minutes to obtain anticorrosive dispersion.

(2) Aluminum isopropoxide is added to the anticorrosive dispersion, stirring evenly. 3 mol/l ammonia water is dropped, and pH is adjusted to 10, stirring at room temperature for 2 hours. After suction filtration, the filter cake was washed with water and dried under vacuum at 90° C. for 1 hour to obtain an anticorrosive sol.

(3) Phytic acid hexaphosphate is added to deionized water with a weight of 30 times weight of phytic acid hexaphosphate, stirring evenly. The anti-corrosive sol is added, and sent to a constant temperature water bath of 60° C., stirring for 1 hour, and discharged and centrifuged. The precipitation is washed and dried at room temperature to obtain a carboxylated anticorrosive sol.

(4) The carboxylated anticorrosive sol is added to thionyl chloride with a weight of 17 times weight of the carboxylated anticorrosive sol, stirred at 50° C. for 15 hours. Thionyl chloride is removed by distillation. Acyl chloride anticorrosive sol is obtained by drying at room temperature.

(5) Graphene oxide is added to anhydrous ethanol with a weight of 100 times weight of graphene oxide, stirred at 1000 rpm for 3 hours. 3-aminopropyltriethoxysilane is added. Anhydrous ethanol is removed by distillation to obtain aminated graphene oxide.

(6) Dodecafluoroheptylpropyltrimethoxysilane is added methyl nylon with a weight of 30-48 times weight of dodecafluoroheptylpropyltrimethoxysilane with sonicated 1 minute to obtain a silane ester solution.

(7) The acyl chloride anticorrosive sol is mixed with the aminated graphene oxide and the mixture is added to deionized water with a weight of 30 times the weight of deionized water, sonicated for 10 minutes and filtered. The precipitate is washed with water, dried at room temperature, added to the silane ester solution. The temperature is raised to 60° C., and the mixture is stirred at 800 rpm for 1 hour and filtered. The precipitate is washed 3 times with methyl nylon methylate and deionized water, and dried under vacuum at 100° C. for 1 hour.

Performance Test:

The anti-corrosive grafted graphene filler of the invention is added to ethyl acetate having a weight of 30-40 times, sonicated for 10-15 minutes. It is added to a conventional epoxy paint, stirred evenly, and coated on the surface of q235 steel plate (2 cm×5 cm×0.1 cm) which has been sanded. The thickness of controlling the film is 0.7-1.0 mm. It is dried at room temperature for 5 days.

After soaking for 3 days in a 3.5 wt % sodium chloride solution, the shear strength of the coating was measured to be 12-12.95 MPa. After soaking for 10 days in a 10 wt % hydrochloric acid solution, the shear strength of the coating was measured to be 12-12.86 MPa. After immersed in 10 wt % sodium hydroxide solution for 3 days, the shear strength of the coating was 13-13.27 MPa.

### Comparative Example

Conventional epoxy coating (consisting of 55 parts epoxy resin, 0.5 parts dimethyl silicone oil, 15 parts 4,4′-diaminodiphenylmethane curing agent) is coated on the surface of q235 steel plate (2 cm×5 cm×0.1 cm) which has been sanded. The thickness of controlling the film is 0.7-1.0 mm. It is dried at room temperature for 5 days.

After soaking for 3 days in a 3.5 wt % sodium chloride solution, the shear strength of the coating was measured to be 10-10.18 MPa. After soaking for 10 days in a 10 wt % hydrochloric acid solution, the shear strength of the coating was measured to be 9.91-10 MPa. After immersed in 10 wt % sodium hydroxide solution for 3 days, the shear strength of the coating was 9-10.13 MPa.

It can be seen from the experiment that the anti-corrosive grafted graphene filler of the invention can be effectively added to the conventional coating, which can effectively enhance the anti-corrosion property for the metal.

### Example 2

An anticorrosive grafted graphene filler for an organic coating consists of the following materials by weight: 0.2 part of triterpenoid saponin, 3 parts of phytic acid hexaphosphate, 1 part of petroleum sodium sulfonate, 4 parts of dodecafluoroheptylpropyltrimethoxysilane, 10 parts of aluminum isopropoxide, proper amount of 3 mol/l of ammonia water, proper amount of sulfoxide, 110 parts of graphene oxide, 1 part of 3-aminopropyltriethoxysilane, and proper amount of methyl nylon.

A method of preparing an anticorrosive grafted graphene filler for an organic coating, comprising:

(1) Petroleum sodium sulfonate is added to deionized water with the weight of 80 times weight of petroleum sodium sulfonate, stirring evenly. Triterpenoid saponin is added and stirred at 70° C. for 10 minutes to obtain anticorrosive dispersion.

(2) Aluminum isopropoxide is added to the anticorrosive dispersion, stirring evenly. 5 mol/l ammonia water is dropped, and pH is adjusted to 12, stirring at room temperature for 3 hours. After suction filtration, the filter cake was washed with water and dried under vacuum at 100° C. for 2 hours to obtain an anticorrosive sol.

(3) Phytic acid hexaphosphate is added to deionized water with a weight of 40 times weight of phytic acid hexaphosphate, stirring evenly. The anti-corrosive sol is added, and sent to a constant temperature water bath of 60-65° C., stirring for 2 hours, and discharged and centrifuged. The precipitation is washed and dried at room temperature to obtain a carboxylated anticorrosive sol.

(4) The carboxylated anticorrosive sol is added to thionyl chloride with a weight of 20 times weight of the carboxylated anticorrosive sol, stirred at 55° C. for 20 hours. Thionyl chloride is removed by distillation. Acyl chloride anticorrosive sol is obtained by drying at room temperature.

(5) Graphene oxide is added to anhydrous ethanol with a weight of 200 times weight of graphene oxide, stirred at 1400 rpm for 4 hours. 3-aminopropyltriethoxysilane is added. Anhydrous ethanol is removed by distillation to obtain aminated graphene oxide.

(6) Dodecafluoroheptylpropyltrimethoxysilane is added methyl nylon with a weight of 30-48 times weight of dodecafluoroheptylpropyltrimethoxysilane with sonicated 2 minute to obtain a silane ester solution.

(7) The acyl chloride anticorrosive sol is mixed with the aminated graphene oxide and the mixture is added to deionized water with a weight of 40 times the weight of deionized water, sonicated for 20 minutes and filtered. The precipitate is washed with water, dried at room temperature, added to the silane ester solution. The temperature is raised to 70° C., and the mixture is stirred at 1000 rpm for 2 hours and filtered. The precipitate is washed 4 times with methyl nylon methylate and deionized water, and dried under vacuum at 110° C. for 2 hours.

Performance Test:

The anti-corrosive grafted graphene filler of the invention is added to ethyl acetate having a weight of 30-40 times, sonicated for 10-15 minutes. It is added to a conventional epoxy paint, stirred evenly, and coated on the surface of q235 steel plate (2 cm×5 cm×0.1 cm) which has been sanded. The thickness of controlling the film is 0.7-1.0 mm. It is dried at room temperature for 5 days.

After soaking for 3 days in a 3.5 wt % sodium chloride solution, the shear strength of the coating was measured to be 12-13.11 MPa. After soaking for 10 days in a 10 wt % hydrochloric acid solution, the shear strength of the coating was measured to be 12.4-13.04 MPa. After immersed in 10 wt % sodium hydroxide solution for 3 days, the shear strength of the coating was 12-13.42 MPa.

### Comparative Example

Conventional epoxy coating (consisting of 55 parts epoxy resin, 0.5 parts dimethyl silicone oil, 15 parts 4,4′-diaminodiphenylmethane curing agent) is coated on the surface of q235 steel plate (2 cm×5 cm×0.1 cm) which has been sanded. The thickness of controlling the film is 0.7-1.0 mm. It is dried at room temperature for 5 days.

After soaking for 3 days in a 3.5 wt % sodium chloride solution, the shear strength of the coating was measured to be 9-10.08 MPa. After soaking for 10 days in a 10 wt % hydrochloric acid solution, the shear strength of the coating was measured to be 8.9-9.91 MPa. After immersed in 10 wt % sodium hydroxide solution for 3 days, the shear strength of the coating was 9.5-10.13 MPa.

It can be seen from the experiment that the anti-corrosive grafted graphene filler of the invention can be effectively added to the conventional coating, which can effectively enhance the anti-corrosion property for the metal.

What is claimed is:

1. An anticorrosive grafted graphene filler for an organic coating, consisting of the following materials by weight: 0.1-0.2 parts of triterpenoid saponin, 2-3 parts of phytic acid hexaphosphate, 0.6-1 part of anticorrosive additive, 2-4 parts of dodecafluoroheptylpropyltrimethoxysilane, 10-15 parts of precursor, 110-120 parts of graphene oxide, 1-2 parts of 3-aminopropyltriethoxysilane.

2. The anticorrosive grafted graphene filler for an organic coating of claim 1, wherein the anticorrosive additive is a mixture of one or two of ethylene diamine tetramethylene diphosphonate sodium and petroleum sodium sulfonate; when it is a mixture, the mass ratio of ethylene diamine tetramethylene diphosphonate sodium and petroleum sodium sulfonate is 2-3:1.

3. The anticorrosive grafted graphene filler for an organic coating of claim 1, wherein the precursor is aluminum isopropoxide.

4. A method of preparing an anticorrosive grafted graphene filler for an organic coating, comprising:
(1) the anti-corrosive additive is added to deionized water with the weight of 76-80 times weight of anti-corrosive additive, stirring evenly; triterpenoid saponin is added and stirred at 60-70° C. for 4-10 minutes to obtain anticorrosive dispersion;
(2) the precursor is added to the anticorrosive dispersion, stirring evenly; 3-5 mol/l ammonia water is dropped, and pH is adjusted to 10-12, stirring at room temperature for 2-3 hours; after suction filtration, the filter cake was washed with water and dried under vacuum at 90-100° C. for 1-2 hours to obtain an anticorrosive sol;
(3) phytic acid hexaphosphate is added to deionized water with a weight of 30-40 times weight of phytic acid hexaphosphate, stirring evenly; the anti-corrosive sol is added, and sent to a constant temperature water bath of 60-65° C., stirring for 1-2 hours, and discharged and centrifuged; the precipitation is washed and dried at room temperature to obtain a carboxylated anticorrosive sol,
(4) the carboxylated anticorrosive sol is added to thionyl chloride with a weight of 17-20 times weight of the carboxylated anticorrosive sol, stirred at 50-55° C. for 15-20 hours; thionyl chloride is removed by distillation. Acyl chloride anticorrosive sol is obtained by drying at room temperature,
(5) graphene oxide is added to anhydrous ethanol with a weight of 100-200 times weight of graphene oxide, stirred at 1000-1400 rpm for 3-4 hours. 3-aminopropyltriethoxysilane is added; anhydrous ethanol is removed by distillation to obtain aminated graphene oxide,
(6) dodecafluoroheptylpropyltrimethoxysilane is added methyl nylon with a weight of 30-48 times weight of dodecafluoroheptylpropyltrimethoxysilane with sonicated 1-2 minutes to obtain a silane ester solution,
(7) the acyl chloride anticorrosive sol is mixed with the aminated graphene oxide and the mixture is added to deionized water with a weight of 30-40 times the weight of deionized water, sonicated for 10-20 minutes and filtered; the precipitate is washed with water, dried at room temperature, added to the silane ester solution; the temperature is raised to 60-70° C., and the mixture is stirred at 800-1000 rpm for 1-2 hours, filtered, and the precipitate is dried to obtain an anticorrosive grafted graphene filler for the organic coating.

5. The method of preparing an anticorrosive grafted graphene filler for an organic coating of claim 4, wherein the specific method for drying the precipitate in the step (7) is as follows: the precipitate is washed 3-4 times with methyl nylon methylate and deionized water, and dried under vacuum at 100-110° C. for 1-2 hours.
